(19) United States
(12) Patent Application Publication
(10) Pub. No.: US 2014/0219752 A1
(43) Pub. Date: Aug. 7, 2014

(54) SLIDING WINCH LIFT SYSTEM

(71) Applicant: GM GLOBAL TECHNOLOGY OPERATIONS LLC, Detroit, MI (US)

(72) Inventors: Spencer W. Chamberlain, Sterling Heights, MI (US); Chet R. Wisniewski, Royal Oak, MI (US)

(73) Assignee: GM Global Technology Operations LLC, Detroit, MI (US)

(21) Appl. No.: 13/757,280

(22) Filed: Feb. 1, 2013

(51) Int. Cl. B60P 1/54

(52) U.S. Cl. CPC B60P 1/54
USPC 414/352; 414/800

(57) ABSTRACT

A number of variations may include a container handling system for an automotive vehicle having a generally horizontal cargo bed area may include a wheeled container for holding cargo, the container may have an alignment surface adjacent a front end of the container; a powered winch connected on the vehicle having a cable for connection with the container, the winch imparting vertical movement to the container; and a guide structure connected on the vehicle for guiding vertical and horizontal movement of the container by interacting with the container alignment surface.

### TECHNICAL FIELD

The field to which the disclosure generally relates to includes apparatus and methods of utilization thereof of container handling systems for automotive vehicles.

### BACKGROUND

A major cost of transporting goods is generated by the labor and time required to load cargo into vehicles and unload cargo from vehicles. The above noted costs are increased wherein the cargo amount is less than a full load.

### SUMMARY OF ILLUSTRATIVE VARIATIONS OF THE INVENTION

A number of variations of the invention may include a container handling system for an automotive vehicle having a generally horizontal cargo bed area. The container handling system may include a wheeled container for holding cargo. The container may have an alignment surface adjacent a front end of the container. A powered winch may be provided that is connected on the vehicle. The winch imparts vertical movement to the container. A guide structure may be connected on the vehicle for guiding vertical and horizontal movement of the container by interacting with the container alignment surface.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a partial perspective view a container handling system according to a number of variations of the invention;

FIG. 2 is a side elevational view of the container handling system shown in FIG. 1;

FIG. 3 is a view similar to that of FIG. 2 illustrating a later stage of operation of the container handling system according to a number of variations of the invention;

FIG. 4 is a schematic view illustrating a stage of operation of moving a container horizontally onto a cargo bed according to a number of variations of the invention;

FIG. 5 is a view similar to FIG. 4 illustrating a later stage operation of loading a container onto the cargo bed of a vehicle according to a number of variations of the invention;

FIG. 6 is a view similar to FIG. 5 illustrating a still later stage operation of loading the container onto the cargo bed of a vehicle according to a number of variations of the invention.

### DETAILED DESCRIPTION OF ILLUSTRATIVE VARIATIONS OF THE INVENTION

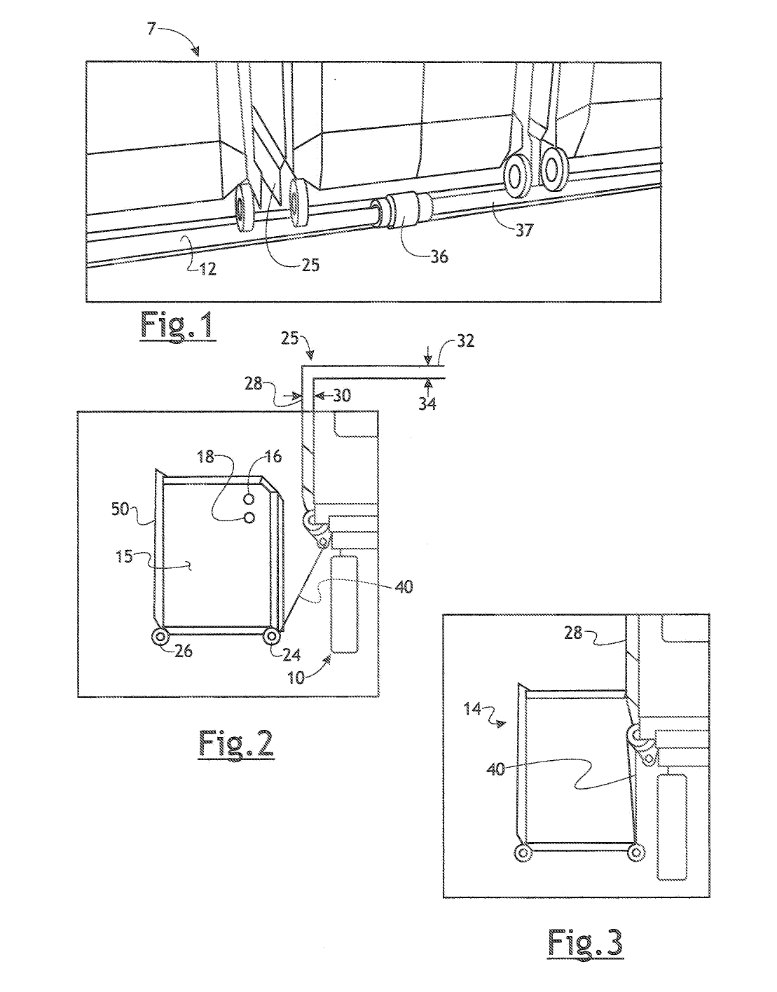

The following description of the variations is merely illustrative in nature and is in no way intended to limit the invention, its application, or uses.A number of variations of the invention are illustrates in FIGS. 1 through 6 and may include a container handling system 7 for automotive vehicle 10. The vehicle 10 may have a generally flat horizontal cargo bed 12. The container handling system may include a container 14. The container 14 may have lateral sides 15. Each lateral side 15 of the container 14 may have an alignment surface provided by vertically aligned out board extending rollers 16 and 18. The rollers 16, 18 may be positioned generally adjacent the front end 20 and top 22 of the container. The container 14 may have an open top or various top, side, front or rear closure devices to allow for the loading or removal of cargo. The container 14 may have a pair of front wheels 24 and rear wheels 26. Typically the container front wheels 24 will have pivotal casters.

The cargo handling system 7 also may have a guide structure 25. A guide structure 25 may be connected with the vehicle 10. The guide structure 25 may have vertical rails 28 and intersecting horizontal rails 32. The vertical rails 28 may provide a channel for the rollers 16 and 18. The vertical rails 28 may have a lower opening allowing for the entry of the rollers 16 and 18 after the container 14 has been rolled into position adjacent to the vehicle 10 and aligned with the guide structure 25. The guide structure 25 by interaction with the rollers 16 and 18 may guide the vertical and horizontal movement of the container 14. A transverse width 34 of the horizontal rail 32 is greater than the transverse width 30 of the vertical rail 28.

The cargo handling system 7 also may be provided with a vehicle connected powered winch 36. The powered winch 36 may be turned by a long shaft 37. The position of the winch 36 may be adjusted with respect to the cargo bed 12 by relocation on the long shaft 37. Connected with the power winch 36 may be a cable 40 (the cable is removed from view in FIG. 1 for clarity of illustration). The cable 40 may be a wire cable, a fabric rope, or any of a multitude a flexible torsional force members such as woven cloth or metal belts. In a number of other variations (not shown) the cable may be provided by a chain. An end of the cable 40 may be provided with a hook (best shown in FIG. 6). The hook 42 may connect to a front end bottom level shackle 44 provided for the container 14.

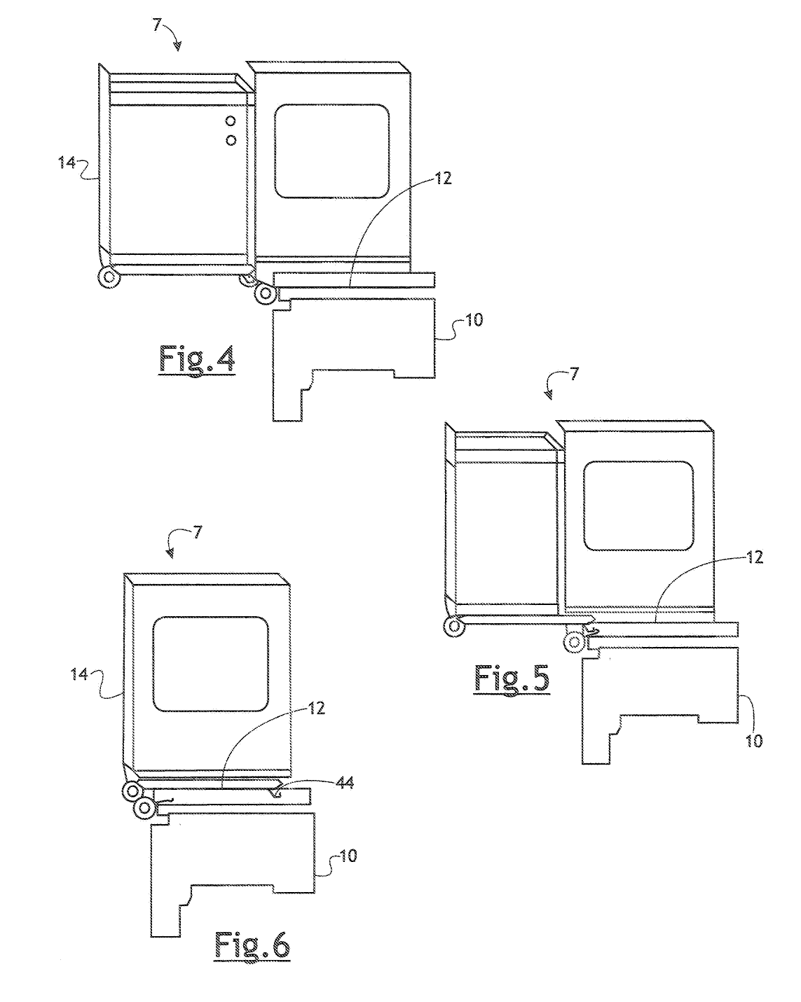

In a number of variations of the invention the cargo that is to be transported by the vehicle 10 may loaded within the container 14. The container 14 may be moved adjacent the vehicle cargo bed 12. The container alignment rollers 16 and 18 may be aligned with the vertical rails 28 of the guide structure 25. Contemporaneously, a hook 42 of the cable 40 may be connected with the shackle 44 of the container. The winch 36 may pull in the cable 40 causing the container 14 to be lifted vertically having the rollers 16 and 18 being captured within the vertical rail 28. Once the rollers 16 and 18 are horizontally aligning with the horizontal rails 32 a vehicle or loading operator may push on a rear end 50 of the container to horizontally move the container 14 onto the vehicle cargo bed 12. The containers front wheels front wheels 24 make contact with the cargo bed 12. As best shown schematically in FIGS. 4 through 6, rightward movement of the container 14 may cause the hook 42 to automatically release the shackle 44 due to the configuration of the hook 42 to shackle 44 interface. For removal of the container 14 from placement on the cargo bed 12, the container 14 may be manually pulled out and the hook 42 is reconnected with the shackle 44 and the winch 36 is utilize to lower the container 14 to a ground position.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other that as expressly described herein and still are considered to be within the scope of the invention.

Variation 1 of the invention may include a container handling system for an automotive vehicle having a generally horizontal cargo bed area including: a wheeled container for holding cargo, the container having an alignment surface adjacent a front end of the container, a powered winch connected on the vehicle having a cable for connection with the container, the winch imparting vertical movement to the container, and a guide structure connected on the vehicle for guiding vertical and horizontal movement of the container by interacting with the container alignment surface.

Variation 2 of the invention may include a container handling system as set forth in Variation 1 wherein the alignment surface is adjacent a top of the container.

Variation 3 of the invention may include a container handling system as set forth in any of Variations 1-2 wherein the alignment surface is provided by a roller.

Variation 4 of the invention may include a container handling system as set forth in any of Variation 1-3 wherein there is a roller on lateral sides of the container.

Variation 5 of the invention may include a container handling system as set forth in any of Variations 1-4 wherein there are two rollers vertically aligned and a transverse width of a horizontal portion of the guide structure is greater than a transverse width of a vertical portion of the guide structure.

Variation 6 of the invention may include a container handling system as set forth in any of Variations 1-5 wherein the cable is connected with the container by a hook.

Variation 7 of the invention may include a container handling system as set forth in any of Variations 1-6 wherein the hook is automatically released from the container by horizontal movement of the container onto the cargo bed.

Variation 8 of the invention may include a container handling system as set forth in any of Variations 1-7 wherein the winch is positioned on a long shaft and the position of the winch may be adjusted on the long shaft.

Variation 9 of the invention may include a container handling system for an automotive vehicle having a generally horizontal cargo bed area as set forth in any of Variations 1-8 wherein the container handling system includes, a wheeled container for holding cargo, the container having on lateral sides vertically aligned rollers adjacent a top front end of the container, a positionally adjustable powered winch connected on the vehicle having a cable with a hook for connection with the container, the winch imparting vertical movement to the container, and a guide structure connected on the vehicle for guiding vertical and horizontal movement of the container by interacting with the container rollers, the guide structure including vertical rails and horizontal rails and wherein a transverse width of the horizontal rails is greater than a transverse width of the vertical rails.

Variation 10 of the invention may include a container handling system as set forth in any Variations 1-9 wherein the hook is automatically released from the container by horizontal movement of the container unto the cargo bed.

Variation 11 of the invention may include a method of handling cargo for transport by a vehicle having a generally horizontal cargo bed including loading a wheeled container with cargo, the container having on lateral sides adjacent a top front ends alignment rollers, moving the container adjacent the vehicle cargo bed, aligning the container rollers with vertical rails connected on the vehicle, connecting with the container a cable connected with a winch connected on the vehicle, pulling the cable in with the winch to causing the container to be lifted vertically and horizontally aligning the rollers with horizontal rails connected with the vehicle, and manually pushing the container horizontally onto the cargo bed.

Variation 12 of the invention may include a method of handling cargo for transport by a vehicle set forth in Variation 11 further including connecting the cable to the container with a hook and automatically releasing the hook from the container by horizontally moving the container onto the cargo bed.

Variation 13 of the invention may include a method of handling cargo for transport by a vehicle as set forth in any of Variations 11-12 further including adjusting the position of the winch with respect to the cargo bed.

The above description of select examples of the invention is merely exemplary in nature and, thus, variations or variants thereof are not to be regarded as a departure from the spirit and scope of the invention.

1. A container handling system for an automotive vehicle having a generally horizontal cargo bed area comprising:
a wheeled container for holding cargo, the container having an alignment surface adjacent a front end of the container;
a powered winch connected on the vehicle having a cable for connection with the container, the winch imparting vertical movement to the container; and
a guide structure connected on the vehicle for guiding vertical and horizontal movement of the container by interacting with the container alignment surface.

2. A container handling system as described in claim 1 wherein the alignment surface is adjacent a top of the container.

3. A container handling system as described in claim 1 wherein the alignment surface is provided by a roller.

4. A container handling system as described in claim 3 wherein there is a roller on lateral sides of the container.

5. A container handling system as described in claim 3 wherein there are two rollers vertically aligned and a transverse width of horizontal portion of the guide structure is greater than a transverse width of a vertical portion of the guide structure.

6. A container handling system as described in claim 1 wherein the cable is connected with the container by a hook

7. A container handling system as described in claim 6 wherein the hook is automatically released from the container by horizontal movement of the container unto the cargo bed.

8. A container handling system as described in claim 1 wherein the winch is positioned on a long shaft and the position of the winch may be adjusted on the long shaft.

9. A container handling system for an automotive vehicle having a generally horizontal cargo bed area comprising:
a wheeled container for holding cargo, the container having on lateral sides vertically aligned rollers adjacent a top front end of the container;
a positionally adjustable powered winch connected on the vehicle having a cable with a hook for connection with the container, the winch imparting vertical movement to the container; and
a guide structure connected on the vehicle for guiding vertical and horizontal movement of the container by interacting with the container rollers, the guide structure including vertical rails and horizontal rails and wherein a transverse width of the horizontal rails is greater than a transverse width of the vertical rails.

10. A container handling system as described in claim 9 wherein the hook is automatically released from the container by horizontal movement of the container unto the cargo bed.

11. A method of handling cargo for transport by a vehicle having a generally horizontal cargo bed comprising:
loading a wheeled container with cargo, the container having on lateral sides adjacent a top front ends alignment rollers;
moving the container adjacent the vehicle cargo bed;
aligning the container rollers with vertical rails connected on the vehicle;
connecting with the container a cable connected with a winch connected on the vehicle;
puffing the cable in with the winch to causing the container to be lifted vertically and horizontally aligning the rollers with horizontal rails connected with the vehicle; and
manually pushing the container horizontally onto the cargo bed.

12. A method of handling cargo for transport by a vehicle as described in claim 11 further including connecting the cable to the container with a hook and automatically releasing the hook from the container by horizontally moving the container onto the cargo bed.

13. A method of handling cargo for transport by a vehicle as described in claim 11 further including adjusting the position of the winch with respect to the cargo bed.
